(19) United States
(12) Patent Application Publication
(10) Pub. No.: US 2013/0060797 A1
(43) Pub. Date: Mar. 7, 2013

(54) DATA TRANSFORMATION METHOD AND SYSTEM

(71) Applicant: Paul Saunier, Scotch Plains, NJ (US)

(72) Inventor: Paul Saunier, Scotch Plains, NJ (US)

(21) Appl. No.: 13/606,703

(22) Filed: Sep. 7, 2012

Related U.S. Application Data
(60) Provisional application No. 61/531,844, filed on Sep. 7, 2011.

(51) Int. Cl. G06F 17/30

(52) U.S. Cl. 707/756; 707/E17.001

(57) ABSTRACT

Systems, methods and devices are provided for transforming data from an input format to an output format on a computing device including an electronic circuit. The methods include receiving, by the electronic circuit, from an input device, an input data record including data in the input format, transforming the data into an output data record format, and outputting an output data record. Additionally, the components of the input data record may be determined using a positional input interface definition including a sample record comprising a input key in each position. Each component is matched to the input key for its position. Components are matched to corresponding components of each position of the output data record, using a positional output interface definition, with the output interface definition including an output key for each record position.

### CROSS-REFERENCE TO RELATED APPLICATIONS

This application is related to and claims priority from U.S. Provisional Patent Application No. 61/531,844, filed on Sep. 7, 2011, by Saunier, titled “Data Transformation Method and System”, which is incorporated herein by reference in its entirety.

### BACKGROUND

1. Statement of the Technical Field

Embodiments generally include systems and methods for transforming data from one or more source formats (input interfaces) into one or more or result formats (output interfaces) provided by a given customer or other such entity.

2. Description of the Related Art

Traditionally, providing data to a particular customer's computer system typically required the expenditure of a lot of time writing customized computer code to adapt to each customer's file format, which are often proprietary. In these cases, is necessary to provide a new program customized for each customer interface, keep track of each program's source and object code, special testing, support and quality assurance inspection, and each program's particular implementation cycle. This potentially consumes a lot of time and resources.

Prior attempts at overcoming these difficulties mostly relied on creating a database of the structural metadata describing individualized file formats. From this, a graphical user interface and “drag and drop” functionality might be used to provide what appeared to be an easy way to create new interfaces—as long as the structural metadata did not change. In many cases, there was a large amount of overhead, including defining database interfaces and record structures to the environment.

A system and method for transforming data from one or more customer interface source format into one or more result formats without intermediate use of a database or metadata store is desirable. Additionally, a method and system for dynamically associating and subsequently invoking one or more functions on any of the data in both the input and output format interface is also needed.

### SUMMARY

Systems, methods and devices are provided for transforming data from an input format to an output format on a computing device including an electronic circuit. The methods include receiving, by the electronic circuit, from an input device, an input data record including data in the input format, transforming the data into an output data record format, and outputting an output data record. Additionally, the components of the input data record may be determined using a positional input interface definition including a sample record comprising a input key in each position. Each component is matched to the input key for its position. Components are matched to corresponding components of each position of the output data record, using a positional output interface definition, with the output interface definition including an output key for each record position.

In an aspect of the invention, the electronic circuit performs the steps of transforming the data from the input data record into an output data record, the output data record having the output format, and, outputting to the output device, the output data record.

In another aspect of the invention, the step of transforming the data further includes the steps of determining the components of the input data record using a positional input interface definition, the positional input interface definition comprising a sample record comprising a input key in each position, wherein each component is interpreted with respect to the input key for its position, and, determining the components of the output data record using a positional output interface definition, the positional output interface definition comprising an output key for each record position, with each component placed into the output data record based on matching the input and output keys for each component.

In a further aspect of the invention, the step of transforming the data further includes determining the components of a second output data record using a second positional output interface definition, the second positional output interface definition comprising a second output key for each record position, each component placed into the second output data record based on matching the input and second output keys for each component.

In one aspect of the invention, the computing device is a stand-alone computer system, such as, but not limited to a mainframe computer, a mini-computer, a personal computer, a tablet computer, a laptop computer, a smartphone, a netbook computer or notebook computer.

In another aspect of the invention, the computing device may be multiple computing devices in a networked computing environment. The networked computing environment may be organized in a client-server architecture. It is also envisioned that a communication network would be employed.

Also disclosed are devices including a non-transient computer readable medium incorporating computer instructions including the above-referenced methods.

### BRIEF DESCRIPTION OF THE DRAWINGS

Embodiments will be described with reference to the following drawing figures, in which like numerals represent like items throughout the figures, and in which:

FIG. 1 is a schematic system diagram of an exemplary system that is useful for understanding the present invention.

FIG. 2 is a block diagram of an exemplary computing device.

FIG. 3 is a flow diagram of an exemplary implementation that is useful for understanding the present invention.

FIG. 4 provides a flow diagram of an exemplary implementation that is useful for understanding the present invention.

FIG. 5 provides a flow diagram of an exemplary implementation that is useful for understanding the present invention.

### DETAILED DESCRIPTION

The present invention is described with reference to the attached figures. The figures are not drawn to scale and they are provided merely to illustrate the instant invention. Several aspects of the invention are described below with reference to example applications for illustration. It should be understood that numerous specific details, relationships, and methods are set forth to provide a full understanding of the invention. One having ordinary skill in the relevant art, however, will readily recognize that the invention can be practiced without one or more of the specific details or with other methods. In other instances, well-known structures or operation are not shown in detail to avoid obscuring the invention. The present invention is not limited by the illustrated ordering of acts or events, as some acts may occur in different orders and/or concurrently with other acts or events. Furthermore, not all illustrated acts or events are required to implement a methodology in accordance with the present invention.

The word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is if, X employs A; X employs B; or X employs both A and B, then “X employs A or B” is satisfied under any of the foregoing instances.

Use of the terms “left”, “first”, “head”, or “beginning” herein to describe the operation of a computer program using the technology, is intended as in common English reading usage, from left to right-the same way a programmer encounters data in a buffer or array of n characters—the leftmost character is character index 0 while the rightmost is character index n−1, where ‘n’ is the number of characters in the array. The first character encountered, therefore, is the leftmost character. The end or last character is therefore the rightmost character.

“Filter”, “filtered”, and “filtering” are used herein to describe the way certain character values may be excluded from a string, a particular character position, a field or fields, or a record in an effort to ensure standards or quality to the data. For example, one may want to exclude any character except digits from a phone number representation. Filtering is one example of how functions are unified with the positional data representation in embodiments of the present invention.

“Head”, as used herein, denotes the beginning of a buffer or map—e.g., the left side. “Tail” as used herein denotes the end of a buffer or map—e.g., the right side.

“Header records”, as referred to herein, are special records containing descriptive metadata. Header records are used to orient a human or computer program as to the nature of the data that follows.

“Metadata”, as used herein, may be of several types: 1. Structural Metadata is the information or “data about the data”. Metadata that is about the data structure is “structural metadata”, information about the logical container in which data is presented or delivered. It describes data structure, that is, how to find or address the data upon which functions, processes, or other actions are applied. It may describe where data is, what data is adjacent to it, or how much there is—e.g., how many bytes exist in a field, for example. 2. Descriptive metadata can be information about a field's contents, frequently the identifier at the top of columns of data in a report, database, or spreadsheet, or the name that programmers would assign to the data “First name”, “Street Address”, “Transaction Amount”, “Zip Code”, and the like. Descriptive metadata is the metadata that insiders will instantly recognize and know how it is to be treated.

“Client-Server”, as used herein, is a phrase used to describe a processing relationship between two processing entities. In the relationship, the client makes a request for service of the server. The server is then expected to respond to the request in a pre-defined way. Thus, the client is normally the requesting or initiating party in a client-server relationship, whereas the server-is the serving or responding party in a client-server relationship.

A “cloud service”, as used herein, is an environment where a client may elicit application services or functions from entities on the internet, world wide web, or other network or facility.

“Justify”, “justified”, and “justification” are used herein to refer to a data convention applied to a field which dictates from which end (left or right) of said field data extraction or deposition is initiated. This is important because when porting input data from a field of one size to an output data field of a different size, justification determines on which side data is either padded or truncated.

“Instantiation”, as used herein, refers to a specific instance of the execution of a program object file, run unit, or executable. Similarly, “object file”, “run unit”, “compiled and linked program”, or “executable”—e.g., in a personal computer environment, an executable program is commonly stored in a file with an “.exe” file extension.

“Map ID”, as used herein, is a string of characters, used as a delimiter, to identify the location and function of a map. For example: |INPUT MAP| is a Map ID used to designate the beginning (head, leftmost) and end (tail, rightmost) of a left-justified input data map.

“Map”, as used herein, is a string in an interface definition, identified and delimited by Map IDs which provides one or more services. Each map is bounded by identical Map IDs as bookends would be around books. The first Map ID (leftmost) is called the Head and the second (and last Map ID) is called the Tail and bounds the map to the right. A purpose of maps is to indicate data characteristics including but not limited to location, justification, field length, and other attributes commonly expected to be included in the nature of fields. A map or maps may also indicate functions or processes to be performed on data including but not limited to: value transformation, value filtration of data, arithmetic operations, up shifting or downshifting, sorting, merging, and other functions commonly performed on data.

“Padding”, “padded”, “pad”, as used herein, refers to the situation wherein a smaller field is moved to a larger field and the left-over character spots are said to be padded. A padding or pad character, typically a blank space, is often used to fill a left-over character spot. Left justified fields are padded to the right with spaces. Right Justified fields are padded to the left, typically with 0 (zero).

“Truncating”, “truncate”, “truncated”, as used herein, refers to the situation wherein a larger field is moved to a smaller field and not all of the data will fit. In that case, some data has to be truncated, that is, trimmed off. Left justified fields are truncated on the right. Right justified fields are truncated on the left.

“DAFOE™”, as used herein, refers to the data and function union interface and is a shorthand for the technology of the inventive systems and methods. DAFOE™ combines but is not limited to the following elements:
Pictorially/position ally represented data elements or structures
Pictorially/position ally represented joining (union) of data and functions
Pictorially/position ally represented routing of data

“Input data”, as used herein, is source data to be integrated, migrated, filtered, transformed, routed, or otherwise processed. Similarly, “output data”, as used herein, is result data after having been routed, filtered, justified, padded, truncated, or otherwise processed. Ideally, output data is the result that an operator, user, client, customer, corporation, government, entity, or individual desires after submitting input data.

Interface definition is used herein to specify a physical or logical portal or I/O environment through which data is input or output, and any number of maps, defining the buffers, run time memory structures, functions to be invoked upon data, and destiny of the data. In addition, auxiliary I/O environments may be specified for the purpose of sorting or other supporting functions.

“I/O environment”, as used herein, is an Input or output environment. The characteristics of an I/O environment include the following: An input or output file, messaging facility, or other interface from which to acquire and/or disseminate data. It is not impossible for the input and output source to be the same physical entity or portal.

“Shadow” or “shadowing” is a term employed herein to show how a function buffer's character indicators are selecting a string in another map for processing. The function buffer's character indicators' indexes correspond to the indexes used in the data description maps |INPUT MAP| and |RJPUTMAP| or |INPUTBUF| and |OUTPUTBUF|. The function or functions associated with a function buffer.

“Match” is a term employed herein to show how data is selected for routing. By matching an input Map |INPUTMAP| character “X” with the exact same value character “X” in an output map |OUTPUTMAP|, the system of the present invention determines that the character from the data input buffer |INPUTBUF| with the identical index as input Map character “X”, should be moved or routed to the data output buffer |OUTPUTBUF| position with the identical index character, subject to the associated functions in adjacent function buffers.

“Structured data records”, as described herein, are fixed length records with fixed length fields that can be represented with a programming structure. Here is an example structured data record as represented in source code: struct map_or_buf_limits {

char firstname [11 ];

char middleinitial[01 ];

char lastname [15 ];

char income [11 ];

char telephone [14 ];

char taxrate [06 ];

char textfield [30 ];

char assets [12 ];

char linefeed [01 ];
};

An “unstructured data file”, as referred to herein, is a stream of bytes which has no added access information embedded in it. It has no index keys, file defined record sizes, embedded record numbers, etc. It is the kind of file created in ANSI C when fopen( ) is called with “w” as the mode parameter. A program reading an unstructured file assumes responsibility for managing the access to the file. An unstructured data file may contain structured records.

The present invention advantageously provides systems and methods for transforming data from one or more source formats (input interfaces) into one or more or result formats (output interfaces) provided by a given customer or other such entity.

Additionally, the present invention advantageously provides methods and systems for dynamically associating and subsequently invoking one or more functions on any of the data in both of one or more input and output interfaces. The term “union” refers to the association of the pictorially represented data interfaces and one or more designated functions.

The present invention also advantageously provides a technology that enables enhanced flexibility in working with structured data records or message structures. In an embodiment of the invention, a simpler (than previously used), more flexible, interface and processing engine is provided. This technology (hereinafter referred to by the acronym “DAFUI™”, which stands for “Data and Function Union Interface”) enables a file or message to be easily changed from one format to another without any programming. It does this without any data dictionaries, data descriptions, or even data names. Instead, DAFUI™ uses pictorial representations of characters, fields, and records. Location and context define the sources of data, what functions are applied to it, and the destination of the data. Using the same simple graphic interface, it can create a data base type “view” of unstructured data, joining any number of unstructured data files via unique key fields. From this “view” any number of unstructured output files can be written and sorted in any record format desired. This technology can be applied not only to batch programs, but also real-time interfaces where instant flexibility is valued.

DAFUI™ supports numerous services, including but not limited to the following: pictorial data definition, data migration, data integration, data transformation, data diversion, data routing and data mapping. A key feature is the ability to associate functions with data using pictures or maps.

Additional advantages of using DAFUI™ include, but are not limited to:
The ability to perform character-based data routing where data manipulation is not limited to fields;
Fields can be redefined dynamically with no programming structure changes;
Memory buffer overruns are virtually impossible; and,
Database-like views of “flat” data can be created through a graphical interface.

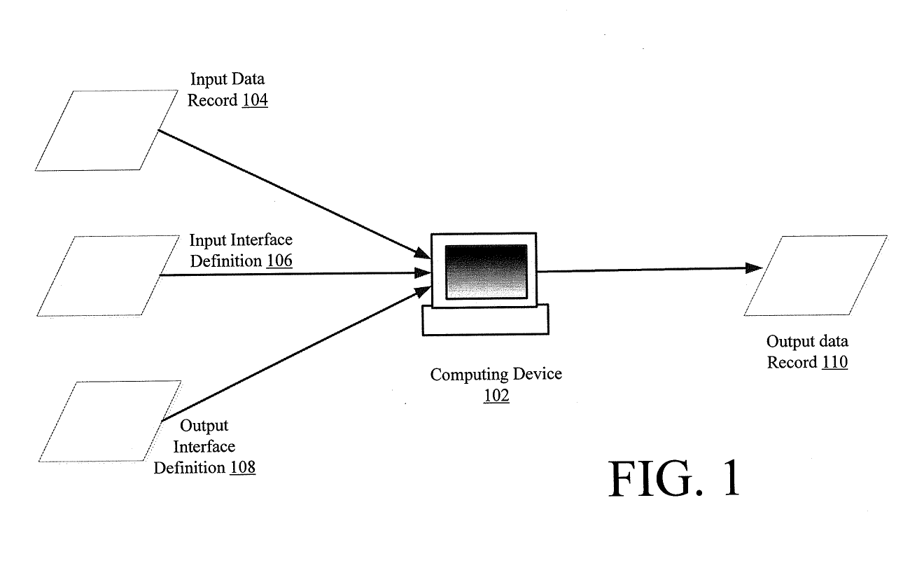

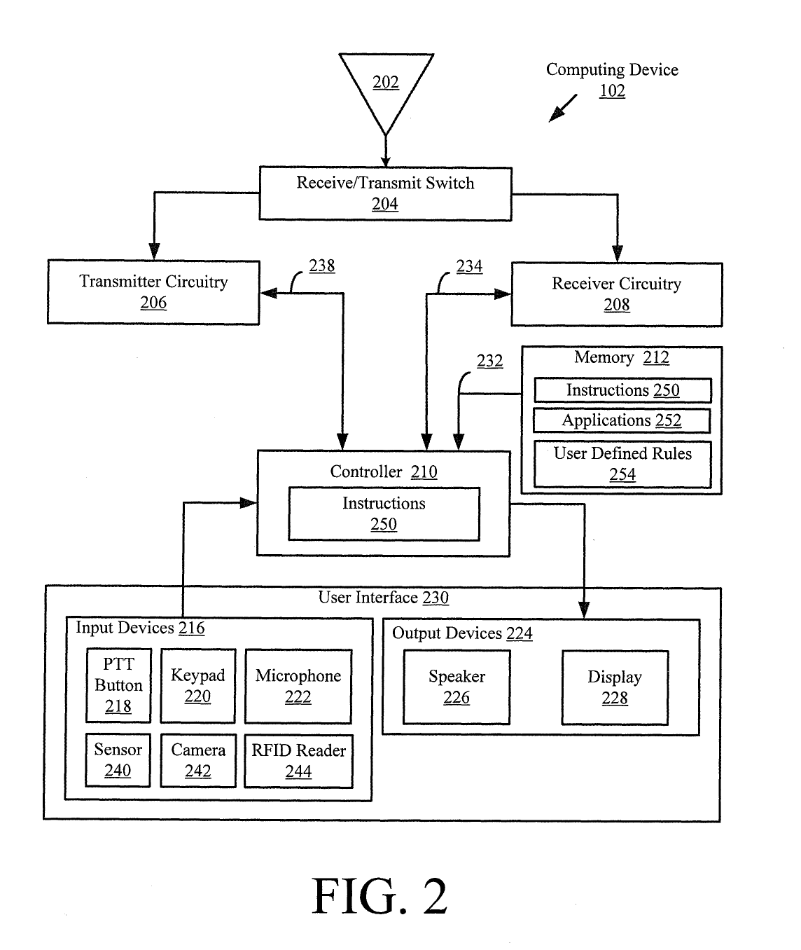

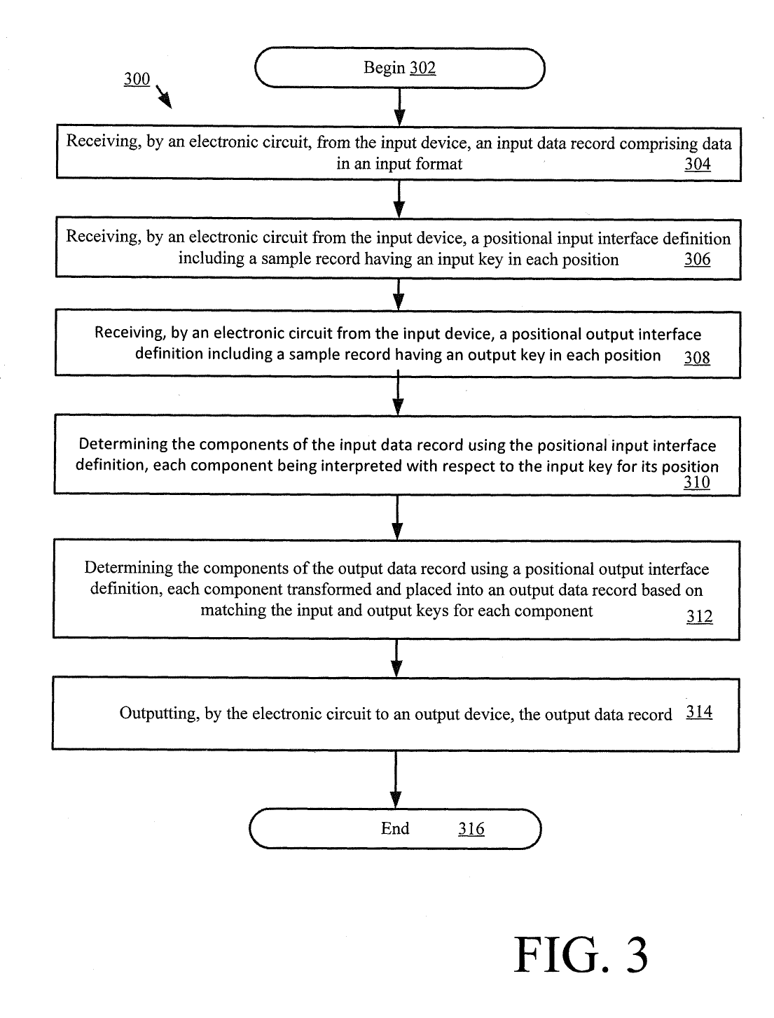

Although described in terms of various components used to implement the methods, the present invention can be used in a variety of system configurations, such as, but not limited to, mobile phone applications, portable computer applications, PDA applications, and the like. Also, various system components may be combined into a few or even one hardware component(s) without affecting overall functionality. Exemplary implementing system embodiments of the present invention will be described below in relation to FIGS. 1-2. Exemplary method embodiments of the present invention will be described below in relation to FIGS. 3-5.

### Exemplary Systems Implementing the Present Invention

Referring now to FIG. 1, there is provided a block diagram of an exemplary system 100 that is useful for understanding various embodiments of the present invention. However, the components shown are sufficient to disclose an illustrative embodiment implementing the present invention. The computing device 102 is configured to receive an input data record 104, an input interface definition 106, also referred to herein as a “positional input interface definition”, and an output interface definition 108, also referred to herein as a “positional output interface definition”. The computing device 102 outputs an output data record. In various embodiments or the present invention, multiple input data records 104, input interface definitions 106, output interface definitions 108, and/or output data records may be input or output, as described herein. The system 100 may include more, less or different components than those illustrated in FIG. 1.

Referring now to FIG. 2, there is provided a more detailed block diagram of the computing device 102. The computing device 102 will be described herein as comprising a personal computer. However, the present invention is not limited in this regard. For example, the computing device can alternatively comprise a PDA, a tablet computer, a smartphone or the like, without limitation.

Notably, the computing device 102 can include more or less components than those shown in FIG. 2. For example, the computing device 102 can include a wired system interface, such as a universal serial bus interface (not shown in FIG. 2). However, the components shown are sufficient to disclose an illustrative embodiment implementing the present invention.

As shown in FIG. 2, the communication device 102 may comprise an antenna 202 for receiving and transmitting Radio Frequency (RF) signals. A receive/transmit (Rx/Tx) switch 204 selectively couples the antenna 202 to the transmitter circuitry 206 and receiver circuitry 208 in a manner familiar to those skilled in the art. The receiver circuitry 208 demodulates and decodes the RF signals received from a network (e.g., the network 104 of FIG. 1) to derive information therefrom. The receiver circuitry 208 is coupled to a controller 210 via an electrical connection 234. The receiver circuitry 208 provides the decoded RF signal information to the controller 210. The controller 210 uses the decoded RF signal information in accordance with the function(s) of the communication device 102. The controller 210 also provides information to the transmitter circuitry 206 for encoding and modulating information into RF signals. Accordingly, the controller 210 is coupled to the transmitter circuitry 206 via an electrical connection 238. The transmitter circuitry 206 may communicate the RF signals to the antenna 202 for transmission to an external device.

The controller 210 stores the decoded RF signal information in a memory 212 of the computing device 102. Accordingly, the memory 212 is connected to and accessible by the controller 210 through an electrical connection 232. The memory 212 can be a volatile memory and/or a non-volatile memory. For example, the memory 212 can include, but is not limited to, a Random Access Memory (RAM), a Dynamic Random Access Memory (DRAM), a Static Random Access Memory (SRAM), Read-Only Memory (ROM) and flash memory. The memory 212 can also have stored therein the software applications 252 and user-defined rules 254.

The software applications 252 may include, but are not limited to, applications operative to provide telephone services, network communication services, Internet connectivity and access services, commerce services, email services, web based services, and/or electronic calendar services.

As shown in FIG. 2, one or more sets of instructions 250 are stored in the memory 212. The instructions 250 can also reside, completely or at least partially, within the controller 210 during execution thereof by the computing device 102. In this regard, the memory 212 and the controller 210 can constitute non-transient machine-readable media. The term “machine-readable media”, as used here, refers to a single medium or multiple media that store the one or more sets of instructions 250. The term “machine-readable media”, as used here, also refers to any medium that is capable of storing, encoding or carrying the set of instructions 250 for execution by the communication device 102 and that cause the communication device 102 to perform one or more of the methodologies of the present disclosure.

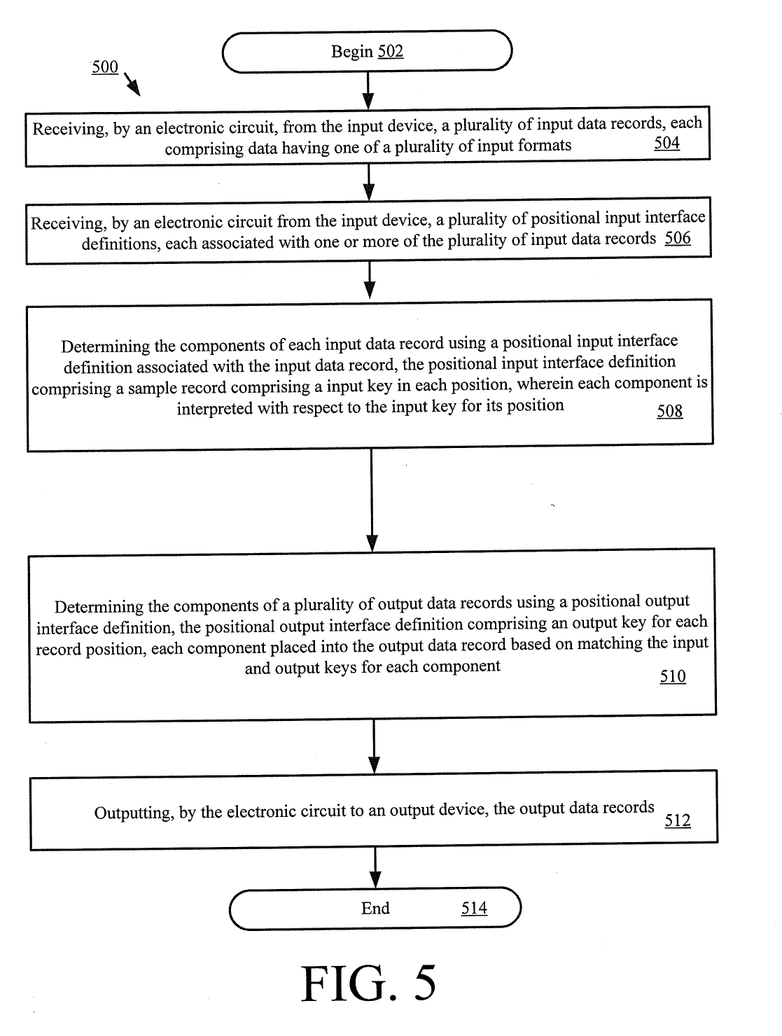

The controller 210 is also connected to a user interface 230. The user interface 230 is comprised of input devices 216, output devices 224, and software routines (not shown in FIG. 5) configured to allow a user to interact with and control software applications 252 installed on the computing device 102. Such input and output devices respectively include, but are not limited to, a display 228, a speaker 226, a keypad 220, a directional pad (not shown in FIG. 5), a directional knob (not shown in FIG. 2), a microphone 222, a Push-To-Talk (“PTT”) button 218, sensors 240, a camera 242 and a Radio Frequency Identification (“RFID”) reader 244.

In operation, the controller 210 together with the other components of the computing device 102 comprise one or more electronic circuit for performing the methods of the present invention.

### Exemplary Methods

Referring now to FIGS. 3-5, there is provided a series of diagrams that illustrate methods for transforming data from an input format to an output format. Exemplary embodiments of the invention are presented in FIGS. 3-5 with respect to methods for transforming data.

Although use of a computing device 102, as described in FIG. 2, is presented herein, the present invention is not limited in this regard. The methods are useful with alternative devices as well, such as portable computer applications, PDA applications, and tablet computing devices, and the like. The methods described in FIGS. 3-5 may be performed by an electronic circuit of the computing device 102, consistent with an embodiment of the invention.

In programming environments, data fields and record structures are defined in the source code when the program is written and determined when a program is compiled into an executable object.

Since the metadata is part of the executable object, at run time and during the life of the running process, there is no opportunity to change data structures after compilation or after instantiation. A change causes a great amount of overhead to be expended when a data structure in a program, or set of programs sharing the data structure, needs to be updated. Frequently, in a typical business environment, the implications are that: a set of programs, a processing system, or a processing subsystem need to be recompiled, retested, and staged for a new software release, incurring unnecessary costs and causing considerable risk.

The present invention allows attributes of a record to be easily changed. For example: the order of fields in a record, the size of fields in a record, as well as the existence of fields. That is, fields may be added or changed without affecting programs that share them.

DAFUI™ enables fields or any strings of data to be associated, character by character, with a function such that that data is processed by the associated function.

Pictorial data and function definition: Input and output data structures are defined and described pictorially and unified with a program's built-in functions. DAFUI™ technology allows a user to change any built-in functions performed on the data by changing the interface description (DAFUI™) to the program. It also allows a user to change any input and/or output data structures without recompiling.

Instead of explicitly writing code to pass the address of each field to be processed to a processing function, DAFUI™ technology instead uses a method of pointing to the data. DAFUI™ indicates symbolically the functions to be invoked upon the data, not limited to fields, but allowing any string of characters so indicated .

This technology allows flexibility in specifying data structures after a program is compiled and additionally during execution.

Reduction in the dependence on Structural metadata including: data names, data descriptions, field lengths, field attributes (including , but not limited to: alphabetic data, alphanumeric data, numeric data, binary data, printable data).

Input or output buffers: The actual Input or output buffers are initialized at program instantiation (run) time by reading one or more initialization (“ini”) files or refreshed in real time via a command, programmatic, messaging, or other interface.

Fields can be dynamically: combined (treated as one by an associated function), boundaries changed, field sizes expanded or truncated, moved to another location in a record, added, deleted, or ignored.

Data structure, data routing (movement), and functions assigned to be performed on the data are unified and associated pictorially in a character based interface medium.

Since the specification of the length of a field or record is a picture and the picture itself is interpreted by the technology, the possibility of buffer overruns is diminished. For example, a programmer may declare a field to be 10 characters in length but he may forget this when coding and may move more than 10 characters to it. This can cause data corruption of adjacent fields or corruption of the data stack resulting in program crashes. With this technology, the actual field specifications are examined and used as the template for data routing decisions. If the destination field is smaller that the source field, the technology detects it and prevents an overrun. Moreover, it is possible to change either the source or destination field sizes (or both) and continue processing without recompiling.

The DAFUI™ technology enables structured files or structured messages exchanged between two or more parties to be dynamically changed by a pre-arranged convention and protocol. In the simplest protocol, the client sends the DAFUI™ at the beginning of every file or message transmission. In a messaging or routing application, this protocol may be enhanced for efficiency to avoid the overhead of interpreting a new DAFUI™ for each message. So rather than sending a new DAFUI™ before each message or file, the arrangement requires a way for the sending (client) party to notify the receiving (server) party that a new DAFUI™ is arriving and is to be used to process subsequent messages or files.

Batch Processing application: A program starts by reading the DAFUI™ from a text or ‘ini’ (initialization) file. The DAFUI™ indicates any number of input interface definitions and any number of output interface definitions. The number of interface definitions is limited only by practical constraints such as available memory and/or performance considerations, and possibly others. Because the built-in functions include sorting and merging, DAFUI™ can create a data base type “view” of unstructured data, joining any number of unstructured data files via unique key fields. From this “view” any number of unstructured output files can be written and sorted in any record format desired.

Dynamic messaging application (client-server scenario): In the simplest protocol, the client appends the DAFUI™ to the beginning of every message. The DAFUI™ server always examines the beginning of the received message for a new DAFUI™. During a client-server session, the latest DAFUI™ received dictates to the server how the data is structured, processed, and routed. The server then processes each input message and routes the output to the destination designated by the DAFUI™ sent by the client. The DAFUI™ server is not pre-aware of what the message structure is, what functions are to be performed on the data, or where the data is going; the operation of the server is completely controlled by the client because the client is providing the DAFUI™.

In a messaging or routing application, this protocol may be enhanced for efficiency to avoid the overhead of interpreting a new DAFUI™ for each message. The arrangement requires a way for the sending (client) party to notify the receiving (server) party that a new DAFUI™ is arriving and is to be used to process subsequent messages until the next time the client notifies the server to use a new DAFUI™.

Dynamic file processing service application (cloud service scenario): In the simplest protocol, the client appends the DAFUI™ as a header to the beginning of every file or begins the session by sending a separate file containing only the DAFUI™. The DAFUI™ server always examines the beginning of the received file or a separate file for a new DAFUI™. During a client-server session, the latest DAFUI™ received dictates to the server how the data is structured and processed. The server then processes the input data and then returns the output to the client. The DAFUI™ server is not pre-aware of what functions are to be performed on the data. The operation of the server is completely controlled by the client because the client is providing the DAFUI™.

DAFUI™ technology supports the following services: Pictorial Data definition, Data migration—Data integration—data transformation—data diversion-data routing—data mapping

In programming environments, data fields and record structures are defined in the source code when the program is written and determined when a program is compiled into an executable object.

Since the metadata is part of the executable object, at run time and during the life of the running process, there is no opportunity to change data structures after compilation or after instantiation. This causes a great amount of overhead to be expended when a data structure in a program, or set of programs sharing the data structure, needs to be updated. Frequently, in a typical business environment, the implications are that a set of programs need to be recompiled, retested, and staged for a new software release, incurring unnecessary costs and causing considerable risk.

This technology allows attributes of a record to be easily changed. For example:
The order of fields in a record
The size of fields in a record.
The existence of fields-fields may be added or changed without affecting programs that share them.
The order of records in a file, that is, the dynamic creation of a file access key.

For example; in a telephone number file the records may be ordered by last name, then first name, then middle name. This could easily be reorganized into separate files ordered by first name, middle initial, last name, or in order by telephone number, all of the above, or any combination.

DAFUI™ technology enables fields or any strings of data to be identified as associated, character by character, with a function such that the data so associated is processed by the associated function without regard to fields or field boundaries.

Descriptive metadata:
can be information about a field's contents, coinciding frequently with the identifier at the top of columns of data, typically the name that programmers would assign to the data “Firstname”, “StreetAddress”, “TransactionAmount”, and the like.
is the metadata that industry insiders will instantly recognize and know how it is to be treated just by looking at it. That is: what the legal or expected contents are (some examples: only digits in a dollar amount field, which special characters are allowed in a name field, what makes a good zip code or phone number, or what the format of a specific kind of account number is).

It is from industry experience that people familiar with the data will know what is to be done with each field, that is; what function or process needs to be applied to it.

For the same reasons, the same users will recognize the boundaries of each field: By looking at raw data they are familiar with, programmers and others familiar with the business data can easily begin to identify the different fields and their boundaries just from the contents. In addition to the boundaries it can also be determined which fields are left justified and which are right justified. This is mostly everything a person familiar with the data needs to know to start forming a DAFUI™.

Example DAFUI™ input and output files are presented in Tables 1-4. Interface definitions are also referred to herein as “positional input interface definition” or “positional output interface definition”.
Table 1: Example input record:
Kyle HTaft 00010000000 81398621Sleepy Drive
Table 2: Example positional input interface definition:
   |INPUTMAP|
nnnnnnnnnnnMLLLLLLLLLLLLLL˜˜˜˜˜˜˜˜˜˜˜˜˜˜˜˜˜DDDDDDDDDDDDDD %
   |RJPUTMAP|
˜˜˜˜˜˜˜˜˜˜˜˜˜˜˜˜˜˜˜˜˜˜˜˜˜˜˜xxxxxxxxxxxRRRRRRR˜˜˜˜˜˜˜˜˜˜˜˜˜˜˜|RJPUTMAP|
Table 3: Example positional output interface definition:
   |OUTPUTMAP|
DDDDDDDDDDDDDDLLLLLLLLLLLLLLLLnnnnnnnnnnn˜RRRRRRxxxxxxxxx %
Table 4: Example output data record:
Sleepy Drive Taft Kyle H 813986010000000

One can see that the first part of the record is a name field and that there appears to be a middle initial, followed by a last name. Then there is a long string of numbers and what appears to be an address.

Record images acquired at run time or during a session are interpreted by the technology , the field attributes are implied by the images created by the user . Keys fields are also indicated by context and may include partial fields or multiple fields. A field's location within the record, it's length, how to handle it (right or left justified). With the technology, it is possible to combine fields , truncate them, expand them, or ignore them .

A data description interface is a set of I/O environments used to describe in a graphic or pictorial way, the nature of the data interfaces to a program using the technology, consisting of an input/output source/destination entity or portal and a set of Data Maps. Data is routed when a character indicator in an input map matches the character indicator in an output map.

Definitions:

A function is built into a program using the technology corresponding to a specific Map ID.

The Map ID defines the function of a map, and/or allows the delimited space between the Map IDs to be used as a data buffer, or a pictorial data description device.

A Map is a symbolic picture of data within a record or interface. There are at least three maps for every record or interface, one describes left-justified data, one describes right-justified data, and one provides a buffer for the actual data. In addition, there may be any number of additional maps, each of which defines a function or test to be performed on the actual data and each map within the interface definition has a unique pair of Map IDs.

Current technology uses field by field text descriptors in the source code: example FIRSTNAMEFIELD PIC X(10) to describe a text field 10 characters long-DAFUI™ technology describes the same data without naming it in the source code or describing it using text. Since the data structure is not named or described in the program source code, a program using the technology is not associated with a specific data structure at compile time.

The first element of the data description interface is the Map or buffer limit string called a Map ID. This identifies the location and function of the Map. A text identifier is used to denote the beginning and end of each I/O environment. Example: |INPUTMAP|

Data Maps: Data Maps provide the interface with a way of representing the data's location and the data's characteristics without specifying them in the source code. This allows the data's location, to be changed in a very flexible way. In the Map |INPUTMAP| the string: nnnnnnnnnnnLLLLLLLLLLLLLLL provides a picture of a person's name: represents a data field containing a person's first name. Since there are 11 ‘n’ characters, the field is 11 characters long. The ‘M’ is another field; middle initial, one character long and contiguous after the first name field. The LLLLLLLLLLLLLLL is the last name field, 15 characters long, contiguous after the middle initial. Map |INPUTMAP| is designated to describe all left-justified fields in a record. Map |RJPUTMAP| is designated to describe all right-justified fields in a record.

Function Maps: A program using the technology may contain any number of built-in functions or services. With each function/service, is associated one or more Maps. To invoke a function's action on a particular string of characters in an input record, the user indicates the selected data parts by specifying with a function defined designated character. This is done by “shadowing” the position of the data in a right justified or left justified input map in the same positions in the function map. For example: In the Map |INPUTMAP| the string: nnnnnnnnnnnmLLLLLLLLLLLLLLL provides a picture of a person's name in a data record. If sorting was to be accomplished, another. the Map, |INSORTMAP|, would be provided, for example containing the string: lllllllllllllllllllllllllll. The second string would “shadow” the string above it character for character and position for position and in that way has selected the three fields (named here only for illustration) ‘nnnnnnnnnnn’ (first name), ‘m’ (middle initial), and ‘LLLLLLLLLLLLLLL’ (last name). The interface technology has designated to the program with a built-in sort function associated with the Map |INSORTMAP| to sort the input record by this string. Function maps may be used for any purpose, including, but not limited to: arithmetic operations, data filtering, and logical decisions.

If multiple programs are using the same DAFUI™, the interface and associated functions are changed for all.

The technology can be used to define an interface on a per message or per file basis in real time. By convention, if the file or message is preceded by a data map, the data following the map can be immediately processed using the map. This means the receiving program (server) can process or route structured data without any prior knowledge of it's structure.

Referring to FIG. 3, a method embodiment of the invention begins with step 302. In step 304, an electronic circuit of a computing device receives from an input device an input data record comprising data in an input format. In step 306, the electronic circuit receives a positional input interface definition including a sample record having an input key in each position. In step 308, the electronic circuit receives a positional output interface definition including a sample record having an output key in each position. Any input device may be used for these records, without limitation. For example, input may be facilitated over a communications network, such as the Internet, from one or more servers (not depicted). As another example, input records may be stored on one or more electronic memory device(s) (also not depicted) in communication with the computing device. Other input devices are also envisioned, as is well known to those of ordinary skill in the computing arts.

Next, at step 310, the components of the input data record are determined using the positional input interface definition, with each component being interpreted with respect to the input key for its position.

At step 312, the components of the output data record are determined using the positional output interface definition, with each component transformed an placed into an output data record based on matching the input and output keys for each component. In step 314, the output data record is outputted by the electronic device. The process is complete at step 316. Again, the output data record may be output to any output device, without limitation. For example, the output data record may be communicated over a communications network to one or more server(s), or written to an electronic memory device, or printed on a printing device, or the like.

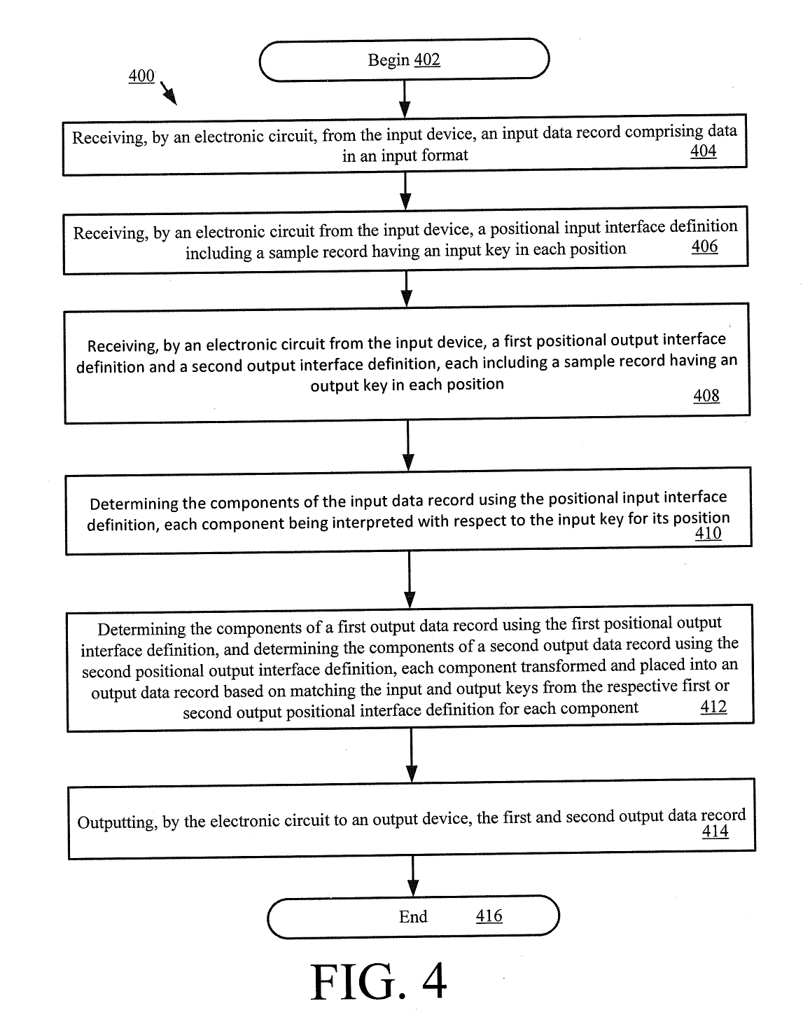

Similarly, FIG. 4 describes an exemplary embodiment of the invention in which a single input data record is transformed into two different data output records. Beginning with step 402, and continuing with step 404—an input data record in an input format is received from an input device (not depicted) by the electronic circuit of a computing device 102. At step 406, the electronic circuit receives a positional input interface definition including a sample record having an input key in each position. At step 408, the electronic circuit receives both a first and a second positional output interface definition, each including a sample record having an output key in each position.

Next, at step 410, the components of the input data record are determined using the positional input interface definition, where each component is interpreted with respect to the input key for its position. At step 412, the components of the first output data record and second output data record are determined using the first and second positional output interface definitions, respectively, with each component transformed and placed into one or both output data record(s) based on matching the input and output keys for each component. At step 414, the first and second output data files are outputted by the electronic circuit.

FIG. 5 is a flowchart describing the processing of multiple input data records, each potentially having its own positional input interface definition. The process begins with step 502 and proceeds to step 504, where the electronic circuit receives a plurality of input data records from the input device, each comprising data having one of a plurality of input formats. Next, at step 506, the electronic circuit receives a plurality of positional input interface definitions from the input device, each associated with one or more of the plurality of input data records.

At step 508, the components of each input data record are determined using a positional input interface definition associated with the input data record, the positional input interface definition comprising a sample record comprising a input key in each position, wherein each component is interpreted with respect to the input key for its position. At step 510, the components of a plurality of output data records are determined using a positional output interface definition, the positional output interface definition comprising an output key for each record position, each component placed into the output data record based on matching the input and output keys for each component. At step 512, the electronic circuit outputs the output data records to an output device, and the process is complete at step 514.

All of the apparatus, methods and algorithms disclosed and claimed herein can be made and executed without undue experimentation in light of the present disclosure. While the invention has been described in terms of preferred embodiments, it will be apparent to those of skill in the art that variations may be applied to the apparatus, methods and sequence of steps of the methods without departing from the concept, spirit and scope of the invention. More specifically, it will be apparent that certain components may be added to, combined with, or substituted for the components described herein while the same or similar results would be achieved. All such similar substitutes and modifications apparent to those skilled in the art are deemed to be within the spirit, scope and concept of the invention as defined.

We claim:

1. A method of transforming data from an input format to an output format on a computing device comprising an electronic circuit, an input device, and an output device, the method comprising:
receiving, by the electronic circuit, from the input device, an input data record comprising data in the input format;
transforming, by the electronic circuit, the data from the input data record into an output data record, the output data record having the output format; and,
outputting, by the electronic circuit to the output device, the output data record.

2. The method according to claim 1, the transforming further comprises:
determining the components of the input data record using a positional input interface definition, the positional input interface definition comprising a sample record comprising a input key in each position, wherein each component is interpreted with respect to the input key for its position; and,
determining the components of the output data record using a positional output interface definition, the positional output interface definition comprising an output key for each record position, each component placed into the output data record based on matching the input and output keys for each component.

3. The method according to claim 1, wherein the computing device comprises a stand-alone computer system.

4. The method according to claim 3, wherein the stand-alone computer system is one of the group comprising:
a personal computer, a tablet computer, a laptop computer, a smartphone, a netbook computer and notebook computer.

5. The method according to claim 1, wherein the computing device comprises a plurality of computer sub-devices running distributed applications in communication over a network.

6. The method according to claim 5, wherein the multiple computer devices are organized in a client-server architecture.

7. The method according to claim 2, further comprising determining the components of a second output data record using a second positional output interface definition, the second positional output interface definition comprising a second output key for each record position, each component placed into the second output data record based on matching the input and second output keys for each component.

8. A system for transforming data from an input format to an output format, comprising
an input device;
an output device;
a computing device comprising an electronic circuit in operative communication with the input device and the output device;
the electronic circuit configured to perform the following operations:
receiving from the input device an input data record comprising data in the input format;
transforming the data from the input data record into an output data record, the output data record having the output format;
outputting the output data record.

9. The system according to claim 8, wherein the electronic circuit is further configured to perform the following operations in the transforming step:
determining the components of the input data record using a positional input interface definition, the positional input interface definition comprising a sample record comprising a input key in each position, wherein each component is interpreted with respect to the input key for its position; and,
determining the components of the output data record using a positional output interface definition, the positional output interface definition comprising an output key for each record position, each component placed into the output data record based on matching the input and output keys for each component.

10. The system according to claim 8, wherein the computing device comprises a stand-alone computer system.

11. The system according to claim 10, wherein the stand-alone computer system is one of the group comprising:
a personal computer, a tablet computer, a laptop computer, a smartphone, a netbook computer and notebook computer.

12. The system according to claim 8, wherein the computing device comprises a plurality of computer sub-devices running distributed applications in communication over a network.

13. The system according to claim 12, wherein the multiple computer sub-devices are organized in a client-server architecture.

14. The system according to claim 9, wherein the electronic circuit is further configured to perform the following operations in the transforming step:
determining the components of a second output data record using a second positional output interface definition, the second positional output interface definition comprising a second output key for each record position, each component placed into the second output data record based on matching the input and second output keys for each component.

15. A device comprising a computer-readable storage medium, having stored thereon a computer program for transforming data from an input format to an output format, the computer program having a plurality of code sections, the code sections executable by a computer to cause the computer to perform the steps of:
receiving, from an input device, an input data record comprising data in the input format;
transforming the data from the input data record into an output data record, the output data record having the output format; and
outputting, to an output device, the output data record.

16. The device according to claim 15, wherein the transforming further comprises:
determining the components of the input data record using a positional input interface definition, the positional input interface definition comprising a sample record comprising a input key in each position, wherein each component is interpreted with respect to the input key for its position; and,
determining the components of the output data record using a positional output interface definition, the positional output interface definition comprising an output key for each record position, each component placed into the output data record based on matching the input and output keys for each component.

17. The device according to claim 15, wherein the computer device comprises a stand-alone computer system.

18. The device according to claim 17, wherein the stand-alone computer system is one of the group comprising:
a personal computer, a tablet computer, a laptop computer, a smartphone, a netbook computer and notebook computer.

19. The device according to claim 15, wherein the computer comprises a plurality of computer sub-devices running distributed applications in communication over a network.

20. The device according to claim 19, wherein the multiple computer devices are organized in a client-server architecture.

21. A method of transforming a plurality of data records from a plurality of input formats to an output format on a computing device comprising an electronic circuit, an input device, and an output device, the method comprising:
receiving, by the electronic circuit, from the input device, a plurality of input data records, each comprising data having one of a plurality of input formats;
receiving, by the electronic circuit, a plurality of positional input interface definitions, each associated with one or more of the plurality of input data records;
determining the components of each input data record using a positional input interface definition associated with the input data record, the positional input interface definition comprising a sample record comprising a input key in each position, wherein each component is interpreted with respect to the input key for its position; and,
determining the components of a plurality of output data records using a positional output interface definition, the positional output interface definition comprising an output key for each record position, each component placed into the output data record based on matching the input and output keys for each component;
outputting, by the electronic circuit to the output device, the output data records.
